(19) United States
(12) Patent Application Publication
(10) Pub. No.: US 2020/0379416 A1
(43) Pub. Date: Dec. 3, 2020

(54) Thermal Storage Device Controller

(71) Applicant: Siemens Schweiz AG, Zurich (CH)

(72) Inventor: Armin Reichlin, Adligenswil (CH)

(73) Assignee: Siemens Schweiz AG, Zürich (CH)

(21) Appl. No.: 16/736,195

(22) Filed: Jan. 7, 2020

(30) Foreign Application Priority Data
Jun. 3, 2019 (EP) 19177935.4

(51) Int. Cl. G05B 13/02; H02S 40/30; H02S 20/23

(52) U.S. Cl. CPC G05B 13/024; H02S 20/23; H02S 40/30

(57) ABSTRACT

Various embodiments include a controller for managing activation of a heating element within a thermal storage device comprising: a processor; a first interface for a signal indicating power from a local grid for the thermal storage device; and a second interface for a signal from a sensor. The first interface is configured to receive the signal via the communication bus. The processor, upon receipt of the enable signal: produces an authentication signal; compares the authentication signal to a predefined signal; and if they match, reads the temperature signal via the second interface to produce a measure of temperature, and compare the produced measure of temperature to a maximum temperature. If the produced measure of temperature is less than the maximum temperature, the processor provides an activation signal. A switch in operative communication with the processor activates the heating element in response to the activation signal.

### CROSS-REFERENCE TO RELATED APPLICATIONS

This application claims priority to EP Application No. 19177935.4 filed Jun. 3, 2019, the contents of which are hereby incorporated by reference in their entirety.

### TECHNICAL FIELD

The present disclosure relates to optimizations for power systems such as rooftop photovoltaic systems. Various embodiments of the teachings herein focus on improved use of power from a local supply of renewable energy.

### BACKGROUND

Buildings with installations for supplying renewable energy are now legion. Power supplied by such installations can, on the hand, be used locally. That is, power is obtained from a local supply of renewable energy and runs local appliances such as dishwashers, television apparatuses, building controllers, kitchen appliances etc. Power from such installations can, on the other hand, be fed to the transmission and/or distribution grid. Power fed to a transmission and/or distribution grid is typically sold at a price that is less than the price of power obtained from such a grid. That is, power will be fed to the grid, if a local supply of renewable power exceeds a local demand for energy.

A European patent application EP2301129A2 describes a controller and a method for controlling a device connected to a power supply. The controller 14 therein detects whether sufficient power from solar power generation is available in a power supply network 2.

If sufficient power is available, a switch 21 activates an appliance 3, 4, 20. The patent application teaches that the appliance 3, 4, 20 can be a washing machine, a storage heater, or a freezer.

A patent application EP2580832A2 describes a thermal storage device controller. The controller 120, 520, 720 manages activation of a heating element 601-603, 745 within a thermal storage device 600, 740. The controller 120, 520, 720 receives a signal indicative of power available within an electricity grid from a network operator. A determination is then made whether to switch the heating element 601-603, 745 to take up available power. That determination is made in response to the signal from the network operator. The heating element 601-603, 745 is then selectively energised as a function of the status of the thermal storage device 600, 740.

A European patent application EP2911018A1 describes a building automation system that uses a predictive model. EP2911018A1 discloses an approach wherein a reading is acquired from an input device such as a power meter, a water meter, an internet router, a temperature sensor, a light sensor etc. The reading is then used as an input to a predictive model 3. An output value of the predictive model 3 is then compared to a measured value 1 and causes of such deviations are identified 7.

### SUMMARY

The present disclosure describes a controller for a thermal storage device. The controller functions to detect if sufficient power from a local supplier of renewable energy is available. Energy available from the local supplier of renewable energy can then be fed to the thermal storage device. For example, some embodiments include a controller (1a; 1b) for managing an activation of at least one heating element (3a, 3b, 3c) within a thermal storage device (2a; 2b), the controller (1a; 1b) comprising: a processor (8); a first interface (4) for receiving an enable signal regarding availability of power from a local supply of renewable power (6a, 6b, 6c) within a local grid (7) for take up by the thermal storage device (2a; 2b); and a second interface (10) for receiving a temperature signal from at least one sensor (11) within the thermal storage device (2a; 2b). The first interface (4) is configured to: connect to a communication bus (13); receive the enable signal via the communication bus (13); and receive a key signal via the communication bus (13). The processor (8) is in operative communication with the first interface (4) and with the second interface (10) and is on receipt of the enable signal configured to: produce an authentication signal as a function of the key signal; compare the authentication signal to a predefined signal; if the authentication signal matches the predefined signal: read the temperature signal via the second interface (10) and produce a measure of temperature from the temperature signal; compare the produced measure of temperature to a maximum temperature; if the produced measure of temperature is less than the maximum temperature: provide an activation signal. The controller (1a; 1b) further comprises a switch (9) in operative communication with the processor (8) and on receipt of the activation signal configured to activate the at least one heating element (3a, 3b, 3c).

In some embodiments, the first interface (4) is configured to receive a disable signal regarding lack of power available from the local supply of renewable power (6a, 6b, 6c) within the local grid (7). The processor (8) is on receipt of the disable signal configured to: provide a deactivation signal; send the deactivation signal to the switch (9); the switch (9) being on receipt of the deactivation signal configured to: deactivate the at least one heating element (3a, 3b, 3c).

In some embodiments, the processor (8) comprises a third interface for unidirectional communication from the processor (8) to the switch (9), the processor (8) being on receipt of the enable signal configured to: produce the activation signal; and to send the activation signal to the switch (9) via the third interface.

In some embodiments, the second interface (10) is configured for unidirectional communication from the at least one sensor (11) to the processor (8); and wherein the second interface (10) comprises a delta-sigma modulation circuit.

In some embodiments, the first interface (4) is configured to: connect to the communication bus (13); receive the enable signal via the communication bus (13); receive a start time signal regarding a start time of availability of power from the local supply of renewable power (6a, 6b, 6c) within the local grid (7) for take up by the thermal storage device (2a; 2b); the processor (8) being on receipt of the enable signal configured to: produce a current time signal indicative of current time; compare the current time signal to the start time signal; and if the current time indicated by the current time signal is later than the start time indicated by the start time signal: provide the activation signal.

In some embodiments, the processor (8) is on receipt of the enable signal configured to: produce a delay signal indicative of a delay time; and to provide the activation signal following expiry of a time interval indicated by the delay signal.

As another example, some embodiments include a controller (1a; 1b) for managing an activation of at least one cooling element (12) within a thermal storage device (2a; 2b), the controller (1a; 1b) comprising: a processor (8); a first interface (4) for receiving an enable signal regarding availability of power from a local supply of renewable power (6a, 6b, 6c) within a local grid (7) for take up by the thermal storage device (2a; 2b); and a second interface (10) for receiving a temperature signal from at least one sensor (11) within the thermal storage device (2a; 2b). The processor (8) is in operative communication with the first interface (4) and with the second interface (10) and is on receipt of the enable signal configured to: read the temperature signal via the second interface (10) and produce a measure of temperature from the temperature signal; compare the produced measure of temperature to a minimum temperature; and if the produced measure of temperature is higher than the minimum temperature: provide an activation signal. The controller (1a; 1b) further comprising a switch (9) in operative communication with the processor (8) and on receipt of the activation signal configured to activate at least one cooling element (12) within the thermal storage device (2a; 2b).

In some embodiments, the first interface (4) is configured to: connect to a communication bus (13); receive the enable signal via the communication bus (13); and receive a key signal via the communication bus (13). The processor (8) being on receipt of the enable signal configured to: produce an authentication signal as a function of the key signal; compare the authentication signal to a predefined signal; and if the authentication signal matches the predefined signal: provide the activation signal.

As another example, some embodiments include a thermal storage device (2a; 2b) comprising: at least one heating element (3a, 3b, 3c) disposed inside the thermal storage device (2a; 2b); at least one sensor (11) disposed inside the thermal storage device (2a; 2b); and a first controller (1a; 1b) as described above, the switch (9) of the first controller (1a; 1b) electrically connecting to the at least one heating element (3a, 3b, 3c) and the first controller (1a; 1b) being in operative communication with the at least one sensor (11).

In some embodiments, there are: at least one cooling element (12) disposed inside the thermal storage device (2a; 2b); and a second controller (1a; 1b) as described above, the switch (9) of the second controller (1a; 1b) electrically connecting to the at least one cooling element (12) and the second controller (1a; 1b) being in operative communication with the at least one sensor (11).

In some embodiments, the thermal storage device (2a; 2b) comprises a housing, wherein the at least one heating element (3a, 3b, 3c), the at least one sensor (11), and the controller (1a; 1b) are arranged inside the housing.

As another example, some embodiments include a local grid (7) comprising: a power management system (5), a local supply of renewable power (6a, 6b, 6c), and at least one thermal storage device (2a; 2b) comprising: at least one heating element (3a, 3b, 3c) disposed inside the at least one thermal storage device (2a; 2b); at least one sensor (11) disposed inside the at least one thermal storage device (2a; 2b); and a controller (1a; 1b) for managing an activation of the at least one heating element (3a, 3b, 3c). The controller (1a; 1b) comprises: a processor (8); a first interface (4) for receiving an enable signal regarding availability of power from a local supply of renewable power (6a, 6b, 6c) within the local grid (7) for take up by the at least one thermal storage device (2a; 2b); and a second interface (10) for receiving a temperature signal from the at least one sensor (11). The processor (8) is in operative communication with the first interface (4) and with the second interface (10) and is on receipt of the enable signal configured to: read the temperature signal via the second interface (10) and produce a measure of temperature from the temperature signal; compare the produced measure of temperature to a maximum temperature; and if the produced measure of temperature is less than the maximum temperature: provide an activation signal. The controller (1a; 1b) further comprising a switch (9) in operative communication with the processor (8) and on receipt of the activation signal configured to activate the at least one heating element (3a, 3b, 3c). The local grid (7) further comprises: a tangible power connector (14), the tangible power connector (14) electrically connecting the local supply of renewable power (6a, 6b, 6c) to the controller (1a; 1b) of the at least one thermal storage device (2a; 2b); a communication bus (13), the first interface (4) of the controller (1a; 1b) being in operative communication with the power management system (5) via the communication bus (13). The tangible power connector (14) is configured to transmit data signals of the communication bus (13) along with electric power.

In some embodiments, the switch (9) of the controller (1a; 1b) electrically connects to the at least one heating element (3a, 3b, 3c).

In some embodiments, the at least one thermal storage device (2a; 2b) electrically connects to the local grid (7).

In some embodiments, the controller (1a; 1b) is in operative communication with the at least one sensor (11).

In some embodiments, the local grid (7) comprises: a high-pass filter (15a; 15b) interposed between the tangible power connector (14) and the first interface (4); wherein the first interface (4) is in operative communication with the power management system (5) via the high-pass filter (15a; 15b).

In some embodiments, the communication bus (13) comprises the tangible power connector (14) and the high-pass filter (15a; 15b).

In some embodiments, the first interface (4) is configured to: connect to the communication bus (13); receive the enable signal via the communication bus (13); and receive a key signal via the communication bus (13). The processor (8) being on receipt of the enable signal configured to: produce an authentication signal as a function of the key signal; compare the authentication signal to a predefined signal; and if the authentication signal matches the predefined signal: provide the activation signal.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic representation of a local grid having two thermal storage devices connected to the grid.

FIG. 2 schematically illustrates a thermal storage device incorporating teachings of the instant disclosure.

FIG. 3 schematically illustrates a thermal storage device incorporating teachings of the instant disclosure, the thermal storage device additionally comprising a cooling element.

FIG. 4 schematically illustrates a local grid incorporating teachings of the instant disclosure, wherein a power bus functions also as a communication bus.

### DETAILED DESCRIPTION

The present disclosure describes a controller for a thermal storage device and a method thereof. As the controller receives an indication of power being available from a renewable supply, the controller determines if the thermal storage device can absorb such power. In positive response of such determination, the controller energizes a heating element and/or a cooling element inside the thermal storage device. The controller thus avoids feeding power to a transmission or distribution grid. Instead, power from a local supply of renewable energy is absorbed locally. In some embodiments, the controller also responds to a lack of or even to an absence of power from an on-site renewable supply. The controller then responds by de-energising the heating element and/or the cooling element.

In some embodiments, the controller factors in a schedule that specifies a start time for energising the heating and/or cooling element. In so doing, management of power available from a renewable supply becomes more nuanced. In some embodiments, the controller functions to delay activation of the thermal storage device. A delay inhibits load peaks caused by simultaneous activations of several thermal storage devices. In some embodiments, a smart thermal storage device has the capacity to determine whether to energise or to de-energise the device.

Some embodiments include a local grid, wherein enable signals, disable signals, authentication signals, schedules etc. are communicated via the mains. The solution largely dispenses with installations of cables for data transmission. Some embodiments include a thermal storage device that is compact and minimises numbers of components that are prone to failure.

In some embodiments, a local grid is compact and minimises numbers of components that are prone to failure. In some embodiments, there is a controller for a thermal storage device, wherein temperatures such as local temperatures inside the thermal storage device are factored into decisions on connection to or on disconnection from a grid.

In some embodiments, a controller for a thermal storage device is operable to be controlled by a cloud service and/or by a grid operator. In some embodiments, a controller for a thermal storage device makes full use of the digital communication capabilities of a controller.

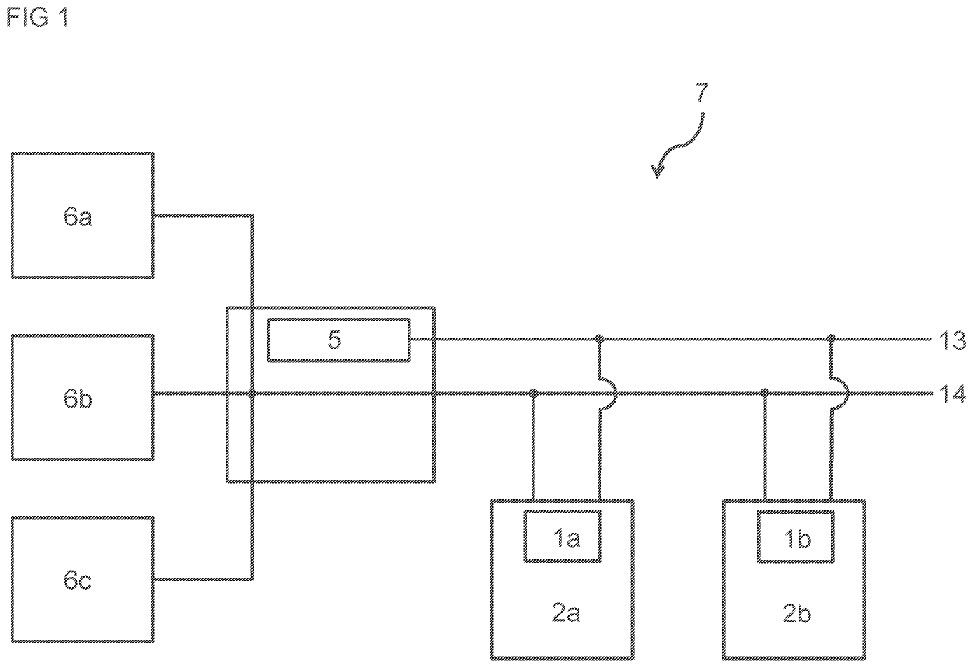

FIG. 1 shows various principal and optional components of a local electricity grid (7) of the instant disclosure. The local grid (7) comprises a supply of renewable power (6a, 6b, 6c). A power bus connects the supply of renewable power (6a, 6b, 6c) to a first thermal storage device (2a) and to a second thermal storage device (2b). The local grid (7) also comprises a power management system (5) such as an energy management system and/or a building management system. The power management system (5) operates the local grid (7). The power management system (5) communicates with the controllers (1a, 1b) of the thermal storage devices (2a, 2b) via a communication bus (13).

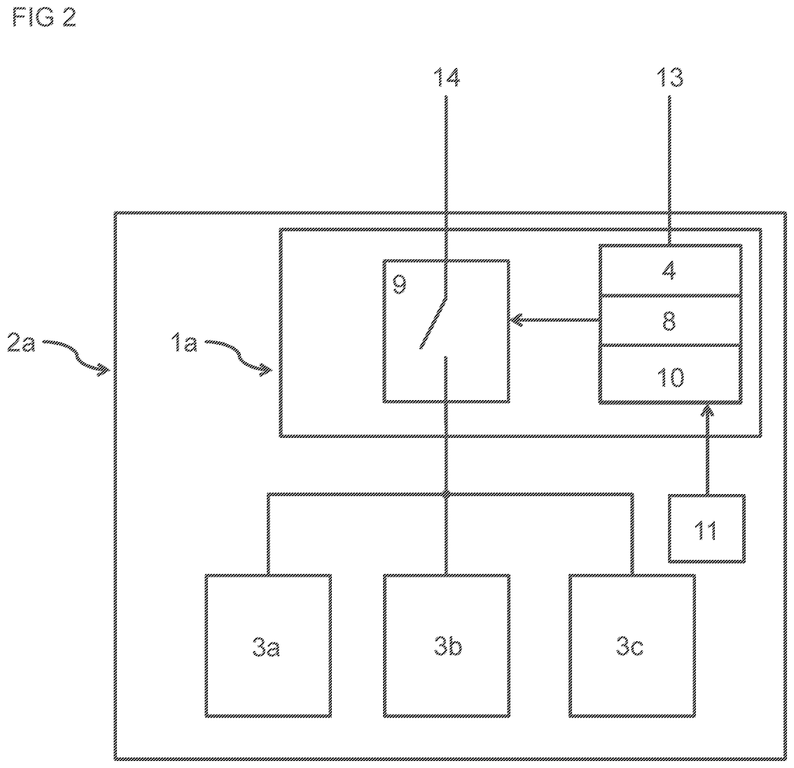

Now turning to FIG. 2, an exemplary thermal storage device (2a) is illustrated. The thermal storage device (2a) comprises three heating elements (3a, 3b, 3c). The heating elements (3a, 3b, 3c) can be energised by activation of a switch (9). The switch (9) receives instructions to energise and/or de-energise the heating elements (3a, 3b, 3c) from a processor (8). A first interface (4) connects the processor (8) to the communication bus (13). The communication bus (13) advantageously is a digital communication bus. A second interface (10) connects the processor (8) to a sensor (10).

In some embodiments, a controller (1a; 1b) for managing an activation of at least one heating element (3a, 3b, 3c) within a thermal storage device (2a; 2b), includes: a first interface (4) for receiving an enable signal regarding availability of power from a local supply of renewable power (6a, 6b, 6c) within a local grid (7) for take up by the thermal storage device (2a; 2b); a second interface (10) for receiving a temperature signal from at least one sensor (11) within the thermal storage device (2a; 2b). A processor (8) on receipt of the enable signal configured to: read the temperature signal via the second interface (10) and produce a measure of temperature from the temperature signal; compare the produced measure of temperature to a maximum temperature; and if the produced measure of temperature is less than the maximum temperature: provide an activation signal. The controller (1a; 1b) further comprises a switch (9) in operative communication with the processor (8) and on receipt of the activation signal configured to activate the at least one heating element (3a, 3b, 3c).

In some embodiments, a controller (1a; 1b) comprises: a first interface (4) for receiving an enable signal regarding availability of power from a local supply of renewable power (6a, 6b, 6c) within a local grid (7) for take up by a thermal storage device (2a; 2b); a second interface (10) for receiving a temperature signal from at least one sensor (11) within the thermal storage device (2a; 2b); and a processor (8) on receipt of the enable signal configured to: read the temperature signal via the second interface (10) and produce a measure of temperature from the temperature signal; compare the produced measure of temperature to a maximum temperature; and if the produced measure of temperature is less than the maximum temperature: provide an activation signal. The controller (1a; 1b) further comprises a switch (9) in operative communication with the processor (8) and on receipt of the activation signal configured to activate at least one heating element (3a, 3b, 3c).

In addition to the aforementioned controllers (1a; 1b), the instant disclosure also teaches methods of managing an activation of at least one heating element (3a, 3b, 3c) within a thermal storage device (2a; 2b). In some embodiments, the method comprises: receiving an enable signal regarding availability of power from a local supply of renewable power (6a, 6b, 6c) within a local grid (7) for take up by the thermal storage device (2a; 2b); receiving a temperature signal from at least one sensor (11) within the thermal storage device (2a; 2b); producing a measure of temperature from the temperature signal; comparing the produced measure of temperature to a maximum temperature; and if the produced measure of temperature is less than the maximum temperature: providing an activation signal; and sending the activation signal to a switch (9). The switch (9) on receipt of the activation signal activating the at least one heating element (3a, 3b, 3c).

The present disclosure also describes tangible machine-readable media having a set of instructions stored thereon that when executed by one or more processors cause the one or more processors to perform the aforementioned method.

The present disclosure also teaches tangible, machine-readable, non-transitory media having a set of instructions stored thereon that when executed by one or more processors cause the one or more processors to perform the aforementioned method.

In some embodiments, the thermal storage device (2a; 2b) comprises at least one heating element (3a, 3b, 3c) and at least one sensor (11). In some embodiments, the aforementioned controller (1a; 1b) is suitable for controlling an activation of at least one heating element (3a, 3b, 3c).

In some embodiments, the processor (8) is configured to: determine whether to switch the at least one heating element (3a, 3b, 3c) to take up available power; and to produce and/or provide the activation signal in positive response of the determination.

The local grid (7) may comprise a local electricity grid. The local grid (7) may comprise a local electricity grid of a structure such as a building. The building can be a residential, a commercial, and/or an industrial building.

The local supply of renewable power (6a, 6b, 6c) may include a local supply of renewable electric power. In some embodiments, the local supply of renewable power (6a, 6b, 6c) comprises a photovoltaic installation and/or at least one solar panel. In another embodiment, the local supply of renewable power (6a, 6b, 6c) comprises a wind turbine.

In some embodiments, the controller (1a; 1b) comprises a first interface (4) for receiving from a local power management system (5) a signal regarding availability of power from a local supply of renewable power (6a, 6b, 6c) within a local grid (7) for take up by the thermal storage device (2a; 2b). In an embodiment, the local power management system (5) is or comprises a local grid operator.

The switch (9) may be configured to connect, preferably to electrically connect, e.g. to directly electrically connect, to the at least one heating element (3a, 3b, 3c). In some embodiments, the switch (9) is configured to: receive the activation signal from the processor (8), and to close a contact in order to connect the at least one heating element (3a, 3b, 3c) to the local grid (7), thereby activating and/or energizing the at least one heating element (3a, 3b, 3c). In some embodiments, the switch (9) comprises a contact such as a mechanical contact, the contact being selectively moveable between an open position and a closed position. In some embodiments, the switch (9) comprises a contact such as a mechanical contact, the contact being selectively moveable between an open position breaking an electric current and a closed position making an electric current. In some embodiments, the switch (9) is or comprises an electric contactor. In some embodiments, the switch (9) is or comprises an insulated-gate bipolar transistor.

In some embodiments, the thermal storage device (2a; 2b) is or comprises a storage heater. In some embodiments, the thermal storage device (2a; 2b) is or comprises a boiler such as a water boiler.

In some embodiments, the at least one heating element (3a, 3b, 3c) comprises a heating wire and/or a heat pump and/or an induction heater. In some embodiments, the at least one heating element (3a, 3b, 3c) is a heating wire and/or is a heat pump and/or is an induction heater.

In some embodiments, the processor (8) is on receipt of the enable signal configured to: produce the activation signal; and to send the activation signal to the switch (9).

In some embodiments, the processor (8) comprises a third interface for sending the activation signal to the switch (9), the processor (8) being on receipt of the enable signal configured to: produce the activation signal; and to send the activation signal to the switch (9) via the third interface.

In some embodiments, the processor (8) comprises a memory such as a non-volatile memory, the processor (8) being in operative communication with the memory, the processor (8) being on receipt of the enable signal configured to: read the maximum temperature from the memory.

In some embodiments, the processor (8) comprises a microprocessor and/or a microcontroller. In some embodiments, the processor (8) is a microprocessor or is a microcontroller.

The at least one sensor (11) may comprise a temperature sensor such as a PT100 sensor or a PT1000 sensor or a fibre optic sensor. The at least one sensor (11) may comprise a temperature sensor such as a PT100 sensor or a PT1000 sensor or a fibre optic sensor.

Fibre optic sensors may confer advantages in explosive and/or hazardous environments.

In some embodiments, the first interface (4) is configured to: connect to a communication bus (13) such as a digital communication bus; and to receive the enable signal from the communication bus (13) using a communication bus protocol such as a digital communication bus protocol.

In some embodiments, a suitable wireless or hard-wired communication bus (13) can be employed to connect the first interface (4) to the power management system (5). The first interface (4) can, by way of non-limiting example, connect to the power management system (5) via a wireless local area network (WLAN) and/or via a Zigbee® wireless connection and/or via a telephony (global systems for mobile communications, GSM) network and/or via a proprietary wireless technique. Also, a concrete wall with high attenuation of radio frequency signals may hinder communication between the first interface (4) and the power management system (5). In order to overcome issues due to noise and/or due to attenuation, the first interface (4) and/or the power management system (5) can harness techniques such as phase-shift keying and/or redundant datagram packets of limited size.

The second interface (10) may comprise an analog-to-digital converter. In some embodiments, the second interface (10) and the processor (8) are arranged on the same system-on-a-chip.

Some embodiments may include any of the aforementioned controllers (1a; 1b), wherein the first interface (4) is configured to receive a disable signal regarding lack of power available from the local supply of renewable power (6a, 6b, 6c) within the local grid (7); wherein the processor (8) is on receipt of the disable signal configured to: provide a deactivation signal; send the deactivation signal to the switch (9); the switch (9) being on receipt of the deactivation signal configured to: deactivate the at least one heating element (3a, 3b, 3c).

In some embodiments, the first interface (4) is configured to receive from a local power management system (5) a signal regarding absence and/or lack of power available from the local supply of renewable power (6a, 6b, 6c) within the local grid (7). In an embodiment, the local power management system (5) is or comprises a local grid operator.

In some embodiments, the processor (8) is on receipt of the disable signal configured to: produce and/or provide the deactivation signal; and to send the deactivation signal to the switch (9); the switch (9) being on receipt of the deactivation signal configured to: deactivate and/or de-energise the at least one heating element (3a, 3b, 3c).

In some embodiments, the third interface of the processor (8) is configured to send the deactivation signal to the switch (9), the processor (8) being on receipt of the disable signal configured to: produce and/or provide the deactivation signal; and to send the deactivation signal to the switch (9) via the third interface; the switch (9) being on receipt of the deactivation signal configured to: deactivate and/or de-energise the at least one heating element (3a, 3b, 3c).

In some embodiments, the processor (8) comprises a third interface for unidirectional communication from the processor (8) to the switch (9), the processor (8) being on receipt of the enable signal configured to: produce the activation signal; and to send the activation signal to the switch (9) via the third interface. Unidirectional communication from the processor (8) to the switch (9) may confer advantages in terms of reduced system complexity.

In some embodiments, the second interface (10) is configured for unidirectional communication from the at least one sensor (11) to the processor (8); and wherein the second interface (10) comprises a delta-sigma modulation circuit. In some embodiments, the second interface (10) having the delta-sigma modulation circuit and the processor (8) are arranged on the same system-on-a-chip. In some embodiments, the interface (10) and/or the processor (8) produce a measure of temperature from the temperature signal using the delta-sigma modulation circuit. Use of delta-sigma modulation confers advantages in terms of substitution of frequency for voltage. Delta-sigma modulation thus affords transmission advantages of a pulse stream. Unidirectional communication from the at least one sensor (11) to the processor (8) may confer advantages in terms of reduced system complexity.

In some embodiments, the first interface (4) is configured to: connect to a communication bus (13); receive the enable signal via the communication bus (13); receive a start time signal regarding a start time of availability of power from the local supply of renewable power (6a, 6b, 6c) within the local grid (7) for take up by the thermal storage device (2a; 2b); the processor (8) being on receipt of the enable signal configured to: produce a current time signal indicative of current time; compare the current time signal to the start time signal; and if the current time indicated by the current time signal is later than the start time indicated by the start time signal: provide the activation signal.

In some embodiments, the processor (8) comprises a clock such as a complementary metal-oxide-semiconductor clock. The processor (8) then produces the current time signal indicative of current time using the clock. In some embodiments, the clock and the processor (8) are arranged on the same system-on-a-chip.

In some embodiments, the first interface (4) is configured to: connect to a communication bus (13); receive the enable signal via the communication bus (13); receive a key signal via the communication bus (13); the processor (8) being on receipt of the enable signal configured to: produce an authentication signal as a function of the key signal; compare the authentication signal to a predefined signal; and if the authentication signal matches the predefined signal: provide the activation signal.

In some embodiments, the first interface (4) is configured to: connect to a communication bus (13); receive the enable signal via the communication bus (13); receive a key signal via the communication bus (13); the processor (8) being on receipt of the enable signal configured to: produce an authentication signal as a function of the key signal; compare the authentication signal to a predefined signal; and if the authentication signal equals the predefined signal: produce and/or provide the activation signal.

In some embodiments, the processor (8) comprises a memory such as a non-volatile memory, the processor (8) being in operative communication with the memory, the processor (8) being on receipt of the enable signal configured to: read the predefined signal from the memory.

In some embodiments, the processor (8) is configured to produce the authentication signal as a hash function of, preferably as a cryptographic hash function of, the key signal. The cryptographic hash function may implement at least one algorithm selected from:
a message digest 5 algorithm;
a secure hash algorithm no 1;
a secure hash algorithm no 2;
a secure hash algorithm no 3;
a secure hash algorithm no 256; or
a bcrypt algorithm.

In some embodiments, the processor (8) is configured to produce an authentication signal as an identity function of the key signal.

In some embodiments, the processor (8) is on receipt of the enable signal configured to: produce a delay signal indicative of a delay time; and to provide the activation signal following expiry of a time interval indicated by the delay signal.

In some embodiments, the processor (8) comprises a memory such as a non-volatile memory, the processor (8) being in operative communication with the memory, the processor (8) being on receipt of the enable signal configured to: read the delay signal from the memory.

In some embodiments, the controller implements the delay signal, wherein the processor (8) is on receipt of the enable signal configured to: produce the delay signal indicative of a delay time, the delay time indicated by the delay signal being less than a maximum delay (time). In some embodiments, the delay signal takes on a random value between a signal indicative of (a) zero delay time and a signal indicative of a maximum delay (time).

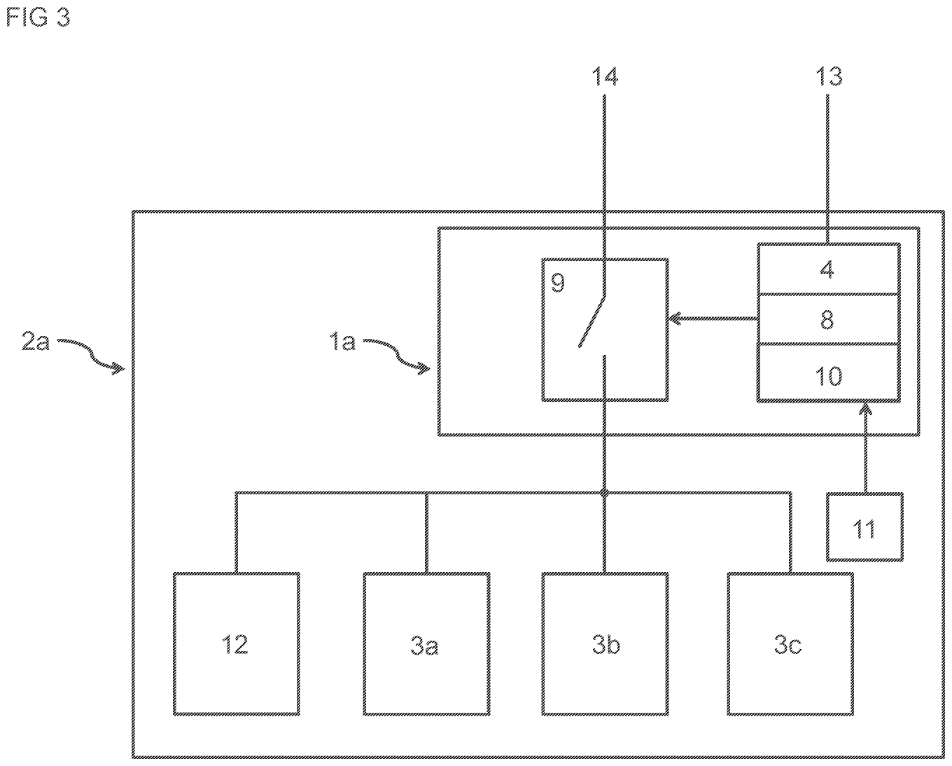

Now referring to FIG. 3, an exemplary thermal storage device (2a) is shown. The thermal storage device (2a) of FIG. 3 additionally comprises a cooling element (12). The cooling element (12) connects to the local grid (7) via the switch (9).

In some embodiments, the processor (8) is on receipt of the enable signal configured to: compare the produced measure of temperature to a minimum temperature; if the produced measure of temperature is higher than the minimum temperature: provide the activation signal; wherein the switch (9) is on receipt of the activation signal configured to: activate at least one cooling element (12) within the thermal storage device (2a; 2b).

In some embodiments, the switch (9) comprises an array of circuit breakers. A first circuit breaker from among the array of circuit breakers connects to the at least one cooling element (12). A second circuit breaker from among the array of circuit breakers connects to the at least one heating element (3a, 3b, 3c). The switch (9) is preferably configured to individually operate circuit breakers from among the array of circuit breakers based on the activation signal. The switch (9) is preferably also configured to individually operate circuit breakers from among the array of circuit breakers based on the deactivation signal.

In some embodiments, the at least one cooling element (12) is or comprises a thermoelectric member. In some embodiments, the at least one cooling element (12) is or comprises a heat pump.

In some embodiments, the thermal storage device (2a; 2b) comprises the at least one cooling element (12). In some embodiments, the at least one cooling element (12) is a cooling element of an installation for heating, ventilation and/or air-conditioning. In some embodiments, the at least one cooling element (12) is a cooling element of a freezer and/or of a fridge.

In some embodiments, the processor (8) comprises a memory such as a non-volatile memory, the processor (8) being in operative communication with the memory, the processor (8) being on receipt of the enable signal configured to: read the minimum temperature from the memory.

In some embodiments, a thermal storage device (2a; 2b) comprises: at least one heating element (3a, 3b, 3c) disposed inside the thermal storage device (2a; 2b); at least one sensor (11) disposed inside the thermal storage device (2a; 2b); and a controller (1a; 1b) as disclosed above, the switch (9) of the controller (1a; 1b) electrically connecting to the at least one heating element (3a, 3b, 3c) and the controller (1a; 1b) being in operative communication with the at least one sensor (11).

In some embodiments, the device (2a; 2b) additionally comprises: at least one cooling element (12) disposed inside the thermal storage device (2a; 2b); and a controller (1a; 1b) connecting to a cooling element (12) as disclosed above, the switch (9) of the controller (1a; 1b) electrically connecting to the at least one cooling element (12) and the controller (1a; 1b) being in operative communication with the at least one sensor (11).

In some embodiments, the thermal storage device (2a; 2b) comprises a freezer. In some embodiments, the thermal storage device (2a; 2b) is or comprises a fridge. In some embodiments, the thermal storage device (2a; 2b) comprises a heat pump. In some embodiments, the thermal storage device (2a; 2b) comprises a circuit for heating, ventilation and/or air-conditioning.

In some embodiments, the thermal storage device (2a; 2b) comprises a housing, wherein the at least one heating element (3a, 3b, 3c), the at least one sensor (11), and the controller (1a; 1b) are arranged inside the housing.

In some embodiments, the at least one cooling element (12) is also arranged inside the housing. In some embodiments, the housing is an enclosure such as a common enclosure. In some embodiments, the housing is made of a metallic material such as steel and/or stainless steel and/or aluminum and/or an alloy thereof.

In some embodiments, a local grid (7) comprises: a power management system (5), a local supply of renewable power (6a, 6b, 6c), and at least one thermal storage device (2a; 2b) as taught above; wherein the at least one thermal storage device (2a; 2b) electrically connects to the local grid (7); wherein the first interface (4) of the at least one thermal storage device (2a; 2b) is in operative communication with the power management system (5).

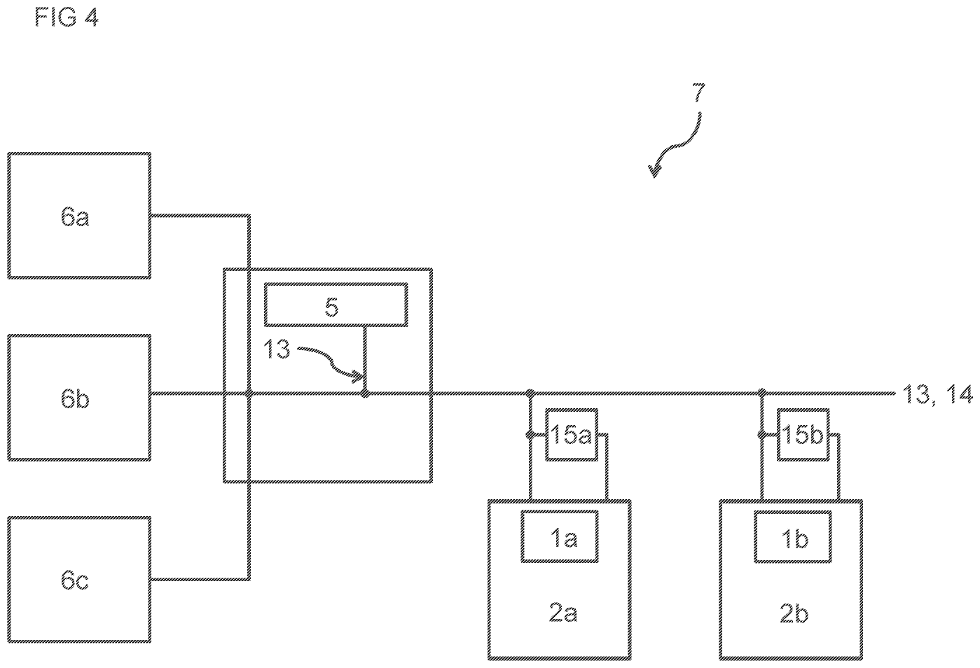

FIG. 4 depicts a solution wherein the communication bus (13) comprises a section that is identical with the power bus (14). The power bus (14) thus carries modulated signals of the communication bus (13). The solution as shown on FIG. 4 allows thermal storage devices (2a; 2b) to be simply plugged into an outlet with no need for a separate connection to a data network.

In some embodiments, the local grid (7) comprising: a tangible power connector (14), the tangible power connector electrically connecting the local supply of renewable power (6a, 6b, 6c) to the controller (1a; 1b) of the at least one thermal storage device (2a; 2b); a communication bus (13), the first interface (4) of the at least one thermal storage device (2a; 2b) being in operative communication with the power management system (5) via the communication bus (13); and wherein the tangible power connector (14) is configured to transmit data signals of the communication bus (13) along with electric power.

In some embodiments, the local grid (7) comprises a high-pass filter (15a; 15b) interposed between the tangible power connector (14) and the first interface (4). The first interface (4) of the at least one thermal storage device (2a; 2b) is in operative communication with the power management system (5) via the high-pass filter (15a; 15b). The communication bus (13) then comprises the tangible power connector (14) and the high-pass filter (15a; 15b).

In some embodiments, the tangible power connector (14) is or comprises a lead. In some embodiments, the tangible power connector (14) is or comprises a wire. In some embodiments, the tangible power connector (14) is or comprises a set of wires.

Any steps of a method incorporating teachings of the present disclosure may be embodied in hardware, in a software module executed by a processor, in a software module being executed using operating-system-level virtualization, in a cloud computing arrangement, or in a combination thereof. The software may include a firmware, a hardware driver run in the operating system, or an application program. Thus, the disclosure also relates to a computer program product for performing the operations presented herein. If implemented in software, the functions described may be stored as one or more instructions on a computer-readable medium. Some examples of storage media that may be used include random access memory (RAM), read only memory (ROM), flash memory, EPROM memory, EEPROM memory, registers, a hard disk, a removable disk, other optical disks, or any available media that can be accessed by a computer or any other IT equipment and appliance.

It should be understood that the foregoing relates only to certain embodiments of the disclosure and that numerous changes may be made therein without departing from the scope of the disclosure as defined by the following claims. It should also be understood that the disclosure is not restricted to the illustrated embodiments and that various modifications can be made within the scope of the following claims.

### REFERENCE NUMERALS

1a, 1b controller
2a, 2b thermal energy storage device
3a, 3b, 3c heating element
4 first interface
5 power management system
6a, 6b, 6c local supply of renewable power
7 local grid
8 processor
9 switch
10 second interface
11 sensor
12 cooling element
13 communication bus
14 tangible power connector
15a, 15b high-pass filter

1. A controller for managing activation of a heating element within a thermal storage device, the controller comprising:
a processor;
a first interface for receiving an enable signal regarding availability of power from a local supply of renewable power within a local grid for the thermal storage device; and
a second interface for receiving a temperature signal from a sensor within the thermal storage device;
wherein the first interface is configured to:
connect to a communication bus;
receive the enable signal via the communication bus; and
receive a key signal via the communication bus;
wherein the processor is in operative communication with the first interface and the second interface and, on receipt of the enable signal, configured to:
produce an authentication signal based at least in part on the key signal;
compare the authentication signal to a predefined signal;
if the authentication signal matches the predefined signal, read the temperature signal via the second interface and produce a measure of temperature from the temperature signal, and compare the produced measure of temperature to a maximum temperature; and
if the produced measure of temperature is less than the maximum temperature, provide an activation signal; and
a switch in operative communication with the processor configured to activate the heating element in response to the activation signal.

2. The controller according to claim 1, wherein:
the first interface is configured to receive a disable signal indicating a lack of power available from the local supply of renewable power within the local grid;
upon receipt of the disable signal, the processor is configured to:
provide a deactivation signal; and
send the deactivation signal to the switch;
upon receipt of the deactivation signal, the switch is configured to deactivate the heating element.

3. The controller according to claim 1, wherein:
the processor comprises a third interface for unidirectional communication from the processor to the switch; and
upon receipt of the enable signal, the processor is configured to:
produce the activation signal; and
send the activation signal to the switch via the third interface.

4. The controller according to claim 1, wherein the second interface is configured for unidirectional communication from the sensor to the processor and comprises a delta-sigma modulation circuit.

5. The controller according to claim 1, wherein the first interface is configured to:
connect to the communication bus;
receive the enable signal via the communication bus;
receive a start time signal indicating a start time of availability of power from the local supply of renewable power for the thermal storage device; and
upon receipt of the enable signal, the processor is configured to:
produce a current time signal indicative of current time;
compare the current time signal to the start time signal; and
if the current time indicated by the current time signal is later than the start time indicated by the start time signal, provide the activation signal.

6. The controller according to claim 1, wherein, upon receipt of the enable signal, the processor is configured to:
produce a delay signal indicative of a delay time; and
provide the activation signal following expiry of a time interval indicated by the delay signal.

7. A controller for managing activation of a cooling element within a thermal storage device, the controller comprising:
a processor;
a first interface for receiving an enable signal indicating availability of power from a local supply of renewable power within a local grid for the thermal storage device; and
a second interface for receiving a temperature signal from a sensor within the thermal storage device;
wherein the processor is in communication with the first interface and the second interface and, upon receipt of the enable signal, the processor is configured to:
read the temperature signal via the second interface and produce a measure of temperature from the temperature signal;
compare the produced measure of temperature to a minimum temperature;
if the produced measure of temperature is higher than the minimum temperature, provide an activation signal; and
a switch in communication with the processor;
wherein, upon receipt of the activation signal, the switch is configured to activate the cooling element.

8. The controller according to claim 7, wherein the first interface is configured to:
connect to a communication bus;
receive the enable signal via the communication bus; and
receive a key signal via the communication bus;
upon receipt of the enable signal, the processor is configured to:
produce an authentication signal as a function of the key signal;
compare the authentication signal to a predefined signal; and
if the authentication signal matches the predefined signal, provide the activation signal.

9. A thermal storage device comprising:
a heating element;
a sensor; and
a first controller comprising:
a processor;
a first interface for receiving an enable signal regarding availability of power from a local supply of renewable power within a local grid for the thermal storage device; and
a second interface for receiving a temperature signal from a sensor within the thermal storage device;
wherein the first interface is configured to:
connect to a communication bus;
receive the enable signal via the communication bus; and
receive a key signal via the communication bus;
wherein the processor is in operative communication with the first interface and the second interface and, on receipt of the enable signal, configured to:
produce an authentication signal based at least in part on the key signal;
compare the authentication signal to a predefined signal;
if the authentication signal matches the predefined signal, read the temperature signal via the second interface and produce a measure of temperature from the temperature signal, and compare the produced measure of temperature to a maximum temperature; and
if the produced measure of temperature is less than the maximum temperature, provide an activation signal; and
a switch in operative communication with the processor, the switch configured to activate the heating element in response to the activation signal and electrically connecting to the heating element;
wherein the first controller is in communication with the sensor.

10. The thermal storage device according to claim 9, further comprising:
a cooling element; and
a second controller comprising:
a processor;
a first interface for receiving an enable signal indicating availability of power from a local supply of renewable power within a local grid for the thermal storage device; and
a second interface for receiving a temperature signal from a sensor within the thermal storage device;
wherein the processor is in communication with the first interface and the second interface and, upon receipt of the enable signal, the processor is configured to:
read the temperature signal via the second interface and produce a measure of temperature from the temperature signal;
compare the produced measure of temperature to a minimum temperature;
if the produced measure of temperature is higher than the minimum temperature, provide an activation signal; and
a switch in communication with the processor;
wherein, upon receipt of the activation signal, the switch is configured to activate the cooling element;
wherein the switch is electrically connected to the cooling element; and
the second controller is in operative communication with the sensor.

11. The thermal storage device according to claim 9, further comprising a housing containing the heating element, the sensor, and the controller.

12. A local grid comprising:
a power management system;
a local supply of renewable power; and
a thermal storage device comprising:
at least one heating element;
a sensor; and
a controller for managing an activation of the heating element, the controller comprising:
a processor;
a first interface for receiving an enable signal regarding availability of power from a local supply of renewable power within the local grid for the thermal storage device; and
a second interface for receiving a temperature signal from the sensor;
wherein the processor is in operative communication with the first interface and the second interface and, upon receipt of the enable signal, the processor is configured to:
read the temperature signal via the second interface and produce a measure of temperature from the temperature signal;
compare the produced measure of temperature to a maximum temperature; and
if the produced measure of temperature is less than the maximum temperature, provide an activation signal;
wherein the controller further comprises a switch in communication with the processor, wherein upon receipt of the activation signal, the switch is configured to activate the heating element;
a tangible power connector electrically connecting the local supply of renewable power to the controller;
a communication bus connecting the first interface of the controller in operative communication with the power management system;
wherein the tangible power connector transmits data signals of the communication bus along with electric power.

13. The local grid according to claim 12, wherein the switch of the controller electrically connects to the at least one heating element.

14. The local grid according to claim 12, wherein the thermal storage device electrically connects to the local grid.

15. The local grid according to claim 12, wherein the controller is in operative communication with the sensor.

16. The local grid according to claim 12, further comprising a high-pass filter interposed between the tangible power connector and the first interface;
wherein the first interface is in operative communication with the power management system via the high-pass filter.

17. The local grid according to claim 12, wherein the communication bus comprises the tangible power connector and the high-pass filter.

18. The local grid according to claim 12, wherein the first interface is configured to:
connect to the communication bus;
receive the enable signal via the communication bus; and
receive a key signal via the communication bus;
wherein the processor, upon receipt of the enable signal, is configured to:
produce an authentication signal as a function of the key signal;
compare the authentication signal to a predefined signal; and
if the authentication signal matches the predefined signal, provide the activation signal.
